(19) United States
(12) Patent Application Publication
(10) Pub. No.: US 2017/0035081 A1
(43) Pub. Date: Feb. 9, 2017

(54) A device for the carbonation of liquids

(71) Applicant: Janne ALASAARELA, Köörtilä (FI)

(72) Inventor: Janne Valdemar Alasaarela, Köörtilä (FI)

(21) Appl. No.: 15/304,076

(22) PCT Filed: Apr. 15, 2015
(86) PCT No.: PCT/FI2015/000014

§ 371 Date: Oct. 14, 2016

(30) Foreign Application Priority Data
Apr. 15, 2014 (FI) 20140110

(51) Int. Cl. A23L 2/54; B01F 3/04

(52) U.S. Cl. CPC A23L 2/54; B01F 3/04801; A23V 2002/00; B01F 2003/049

(57) ABSTRACT

A device intended for the carbonation of liquids, to which is added safety, simplified usage and operating principles, and decreased production costs. The device is typically intended for domestic use and it is suitable for use, for example, with water-filled soft drink bottles and a 425 g refillable carbon dioxide gas cylinder. The device is attached to the liquid-filled bottle, and turning the device and the bottle like a lever against the threaded portion of the carbon dioxide gas cylinder causes carbon dioxide to flow into the liquid. The device is provided with a relief valve, and the device is not firmly attached to the carbon dioxide gas cylinder. Thus, incorrect use, e.g. dropping the device, will not result in harm to the carbon dioxide gas cylinder or to the user.

### FIELD OF THE INVENTION

The illustrative and non-limiting embodiments of this invention relate generally to devices and methods for carbonating a liquid.

### EXPLANATION

### Background

In a pressurized state, carbon dioxide dissolves well in fluids, such as cold water. This property is used, for example, in the manufacture of soft drinks. Carbon dioxide is added to beverages as a preservative, to remove oxygen. The taste of carbonic acid is popular. Carbonated liquids are prepared using a variety of devices. The source of carbon dioxide used is commonly refillable carbon dioxide gas cylinders in carbonation devices designed for household use, such as table model carbonation devices or devices integrated in refrigerators. There are inventions in existence that utilize used containers, such as empty soft drink bottles, for the above purpose. These devices operate in such a way that a carbon dioxide gas cylinder is connected to the device, and the device is used to acidify the liquid in the bottle. In some cases, the bottle containing the liquid is attached by a snap-fastening, in some devices by turning. Nozzles that disperse bubbles generally assist the dissolution of carbon dioxide in the liquid. All previous solutions designed for domestic needs, and involving the use of small, refillable carbon dioxide gas cylinders, are relatively complicated and bulky, owing in part to the need to ensure the safety of pressure equipment. The devices are equipped with a relief valve, or pressure regulator, or both. Refillable carbon dioxide gas cylinders may be provided with a thread or other mechanical fastener and a needle valve.

We are not aware of a commercially available inexpensive, small, hand-operated, but nonetheless safe solution. The invention provides a solution to this need.

The invention differs from previous devices, such as patent U.S. Pat. No. 5,531,254 A, in that the carbon dioxide gas cylinder is not firmly fitted into the device. The device is attached to the carbon dioxide gas cylinder only when it is desired that carbon dioxide should flow into the container to be filled. This achieves an exceptionally good level of safety in the sense that if there is an error in the device or its operation, and even if the device and the carbon dioxide gas cylinder should accidentally fall onto the floor, the device is immediately released from the carbon dioxide gas cylinder, and carbon dioxide does not flow from the cylinder. In addition, there is no risk that the device and the attached liquid-filled bottle will cause damage to the actual carbon dioxide gas cylinder in such a situation. Furthermore, the device contained by the invention is compact and simple, and therefore inexpensive to produce.

### SUMMARY

The following presents a simplified summary of the invention to support understanding of certain essential aspects of the invention. This summary is not a comprehensive overview of the invention.

One aspect of the invention relates to a hand-operated device, including a retainer, sliding surface, and valve opener, for carbonating a liquid. The device includes a retainer, relative to which the device is rotated against the carbon dioxide gas cylinder, a sliding surface that presses the carbon dioxide gas cylinder against the retainer in a rotational motion, and a valve opener, which opens the valve of the carbon dioxide gas cylinder at the end of the rotational motion.

One aspect of the invention relates to a method for carbonating a liquid, in which method the carbon dioxide gas bottle is placed against the retainer, and the device is rotated around the retainer so that the sliding surface presses the carbon dioxide gas cylinder against the retainer, and the retainer and sliding surface guide the rotational motion, so that the valve opener pushes open the carbon dioxide gas cylinder valve, and carbon dioxide flows through the device and into the liquid.

Other embodiments of the invention are disclosed in dependent patent claims.

The present solution allows the safe, low cost carbonation of a liquid.

Although several different aspects, embodiments, and features of the invention have been described independently, it is to be understood that all combinations of several aspects, embodiments, and features of the invention are possible and belong within the scope of protection of the invention presented in the present patent claims.

### LIST OF DRAWINGS

FIG. 1 shows a cross section of an embodiment of the device.

FIG. 2 shows a three-dimensional pictorial representation of an embodiment.

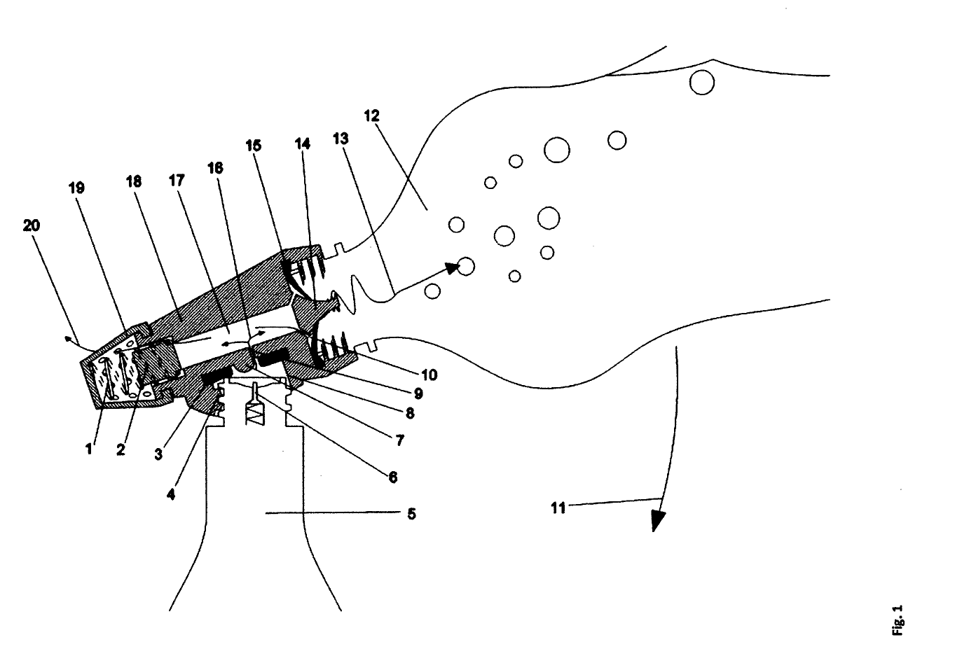

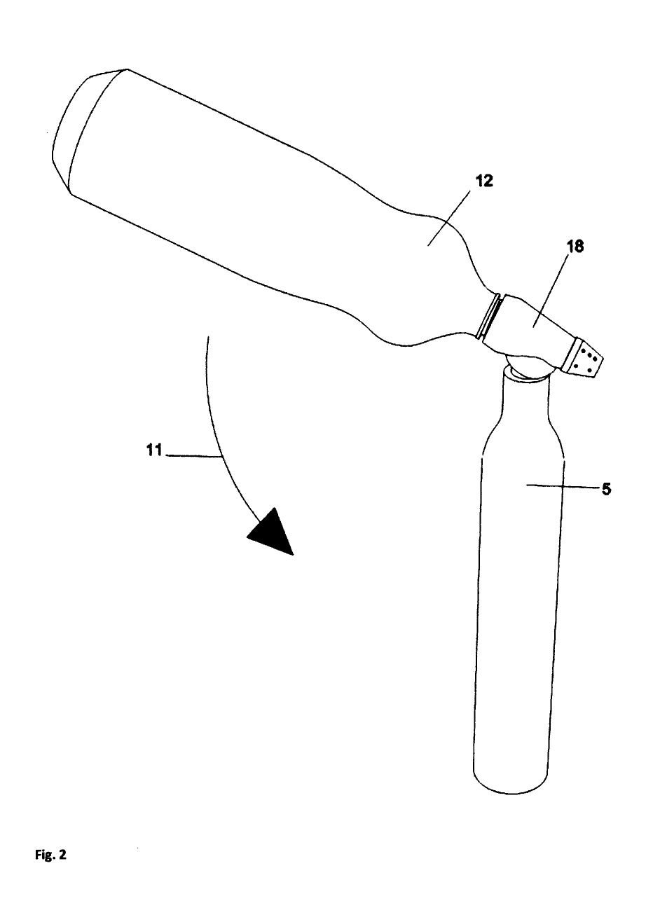

Shown in the drawings (FIG. 1 and FIG. 2):

(1): steel spring

(2): relief valve equipped with a seal

(3): the seal between the carbon dioxide gas cylinder and the device

(4): retainer; the shape, on the device, of the horizontal rotational motion of the thread part of the carbon dioxide gas cylinder

(5): 425 g refillable carbon dioxide gas cylinder

(6): needle valve on the carbon dioxide gas cylinder

(7): the valve opener, a round pin on the device that opens the valve on the carbon dioxide gas cylinder

(8): sliding surface

(9): a small channel from the stem of the pin that opens the carbon dioxide gas cylinder, which channel constricts the carbon dioxide, making it flow at a safe rate

(10): a small channel from the central chamber, which constricts the carbon dioxide, making it flow at a safe rate

(11): the movement opening the carbon dioxide gas cylinder

(12): 1.5 litre soft drink bottle, filled with cold water

(13): carbon dioxide flows into the liquid

(14): pin, the shape of which causes the carbon dioxide to diffuse

(15): circular sealing plate, e.g. a silicon disk, with a central hole

(16): carbon dioxide emerging from the carbon dioxide gas cylinder

(17): cavity in the centre of the device, central chamber

(18): device

(19): perforated spring holder

(20): flow of carbon dioxide under positive pressure

### DETAILED DESCRIPTION OF THE INVENTION

Illustrative embodiments of the present invention will be described below in greater detail with reference to the accompanying drawings, which show one embodiment of the invention, but not all of them. The invention may thus be implemented in many different ways and should not be understood as being restricted to the embodiments set forth here. Although the specification may in several places in the text refer to “a(n)”, “one”, or “some” embodiment(s), this does not necessarily mean that each reference is made to the same embodiment/the same embodiments or that a particular feature only applies to any single embodiment. Single features of different embodiments may also be combined to provide other embodiments.

The following shows one embodiment of the invention with the aid of images (FIGS. 1 and 2). The device (18) is rotated onto a liquid filled bottle (12), for example a 1.5 litre soft drink bottle, filled with cold water. Using the bottle (12) as a handle, the device (18) is first attached at an angle onto the carbon dioxide gas cylinder (5), for example a 425 g refillable carbon dioxide gas cylinder. The bottle (12), and thus also the device (18), are turned in the direction of the arrow (11) until carbon dioxide is seen bubbling into the liquid. The form of the horizontal rotational motion of the threaded portion of the carbon dioxide gas cylinder (5), the retainer (4), is modelled and shaped on the device (18). When the device (18) is rotated with the retainer (4) against the threaded portion of the carbon dioxide gas cylinder (5), the sliding surface (8) presses the carbon dioxide gas cylinder (5) against the retainer (4), and the needle valve (6) of the carbon dioxide gas cylinder (5) is guided towards the valve opener (7), and the carbon dioxide gas cylinder (5) is pressed against the seal (3), and the valve opener (7) opens the valve (6) on the carbon dioxide gas cylinder (5). Now, the carbon dioxide flows in the direction of the arrow (16) from the carbon dioxide gas cylinder (5) through the channel (8) to the central chamber (17), from which it flows first in the direction of the arrow (13) into the channel (10) and from there through the valve formed by the seal (15) and pin (14) into the bottle (12) rotated into the device (18). At this stage, the bottle (12) containing the water begins to feel rock hard, and when the target pressure is reached, the relief valve (2) pressed by the spring (1) opens and carbon dioxide flows out in the direction of the arrow (20) via the perforated spring holder (19). Thus, the user understands to stop the supply of carbon dioxide and turns the bottle (12), and thus also the device (18) against the direction of the arrow (11).

In one embodiment of the invention, the seal (15) is integrated into the gas diffuser to reduce the size of the gas bubbles and thus enhance the dissolution of carbon dioxide in the liquid.

In one embodiment of the invention, the gas diffuser is integrated by modelling or other means into the pin (14) to reduce the size of the gas bubbles and thus enhance the dissolution of carbon dioxide in the liquid.

In one embodiment of the invention, the device (18) is provided with a pressure gauge.

In one embodiment of the invention, the device (18) is provided with a pressure regulator.

In one embodiment of the invention, the device (18) is designed to be produced from plastic by injection moulding.

In one embodiment of the invention, the device (18) is designed to be produced by a 3D printer.

In one embodiment of the invention, carbon dioxide is led from the device (18) along a flexible hose and into the liquid.

In one embodiment of the invention, either the retainer (4) or the sliding surface (8) or both are separate parts at least partly moveable, either under control or freely.

In one embodiment of the invention, the device (18) or the spring holder (19), provides audible notice after the relief valve (2) opens.

In one embodiment of the invention, the device (18) is placed on top of the carbon dioxide gas cylinder (5), and the device (18) is rotated against the direction of the arrow (11), so that the valve (6) on the carbon dioxide gas cylinder valve (5) opens.

It is clear to professionals in the field that as technology advances, inventive thinking can be implemented in different ways. The invention and its embodiments are not restricted to the examples described above but may vary within the scope of the patent claims.

1. A hand-operated device (18) for carbonating a liquid, including at least the following parts:
a retainer (4)
a sliding surface (8)
a valve opener (7)
Characterised by a retainer (4) relative to which the device (18) is rotated (11) against the carbon dioxide gas cylinder (5), as well as a sliding surface (8), which presses the carbon dioxide gas cylinder (5) against the retainer (4) in a rotational motion (11), and a valve opener (7), which opens the valve (6) of the carbon dioxide gas cylinder (5) at the end of the rotational motion (11).

2. A device according to claim 1, characterized in that the retainer (4) has substantially the rotational form of the thread part of the carbon dioxide gas cylinder (5).

3. A device according to claim 1 characterized in that the clamping force of the liquid-filled container (12) attached to the device (18) compresses the valve formed from the pin (14) and seal (15), where the carbon dioxide is allowed to flow (13) into the liquid, but not back into the device (18).

4. A device according to claim 1, characterized in that it is provided with one or more of the following elements: a relief valve (2), a pressure gauge, a pressure regulator.

5. A device according to claim 1, characterized in that the liquid is a drink containing a substantial amount of water.

6. A method for carbonating liquids, characterized in that, in the said method, a carbon dioxide gas cylinder (5) is placed against a retainer (4), and the device (18) is rotated (11) around the retainer (4) so that the sliding surface (8) presses the carbon dioxide gas cylinder (5) against the retainer (4), and the retainer (4) and sliding surface (8) guide the rotational motion (11), so that the valve opener (7) pushes open the valve (6) of the carbon dioxide gas cylinder (5), and carbon dioxide flows (16,13) through the device (18) and into the liquid.
